(19) United States
(12) Patent Application Publication
(10) Pub. No.: US 2023/0061157 A1
(43) Pub. Date: Mar. 2, 2023

(54) ADJUSTING VIDEO CONTENT BASED ON AUDIENCE EXPERIENCES

(71) Applicant: International Business Machines Corporation, Armonk, NY (US)

(72) Inventors: Saraswathi Sailaja Perumalla, Visakhapatnam (IN); Venkata Vara Prasad Karri, Visakhapatnam (IN); Omkar Nath Bag, Balangir (IN); Sandeep Kaur, Harbour colony (IN); Sai Giridhar Thutupalli, Visakhapatnam (IN)

(21) Appl. No.: 17/460,597

(22) Filed: Aug. 30, 2021

(51) Int. Cl. H04N 21/2668; H04N 21/2665; H04N 21/442

(52) U.S. Cl. CPC H04N 21/2668; H04N 21/2665; H04N 21/44218

(57) ABSTRACT

Computer technology for making sure that no viewer in an audience of multiple co-viewers will effectively be presented with audiovisual content portions that inappropriate and/or irrelevant for that co-viewer. Avoiding the effective presentation of inappropriate and/or irrelevant content to one or more of the co-viewers may involve currently conventional techniques such as blurring, scrambling, obscuring, distracting, etc.

### BACKGROUND

The present invention relates generally to the field of presenting audiovisual content (herein sometimes referred to as “video content”) based upon projected audience member experiences for an audience having multiple members, as contrasted with single viewer audiences.

### SUMMARY

According to an aspect of the present invention, there is a method, computer program product and/or system for use with a first video presentation data set that includes audiovisual content in the form of a first video presentation and further for use with a plurality of co-viewers who want to watch the first video presentation together as a group that performs the following operations (not necessarily in the following order): (i) receiving, from the first co-viewer and through a communication network, a request to view the first video presentation on a first audiovisual presentation device of the first co-viewer; (ii) receiving a co-viewer context data set which includes information indicative of: (a) identities of all co-viewers of the plurality of co-viewers, and (b) for each given co-viewer of the plurality of co-viewers, personal context information including attributes related to the given co-viewer; and (iii) for each given co-viewer of the plurality of co-viewers, determining, based at least in part on the co-viewer context data set, by an artificial intelligence algorithm: (a) irrelevant portions, if any, of the first video presentation that are irrelevant with respect to the given co-viewer, and (b) inappropriate portions, if any, of the first video presentation will be inappropriate for the given co-viewer.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a diagram helpful in understanding various embodiments of the present invention.

FIG. 6 is another diagram helpful in understanding various embodiments of the present invention.

FIG. 7 is a flowchart showing a second embodiment of method according to the present invention; and

FIG. 8 is a block diagram of a second embodiment of a system according to the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

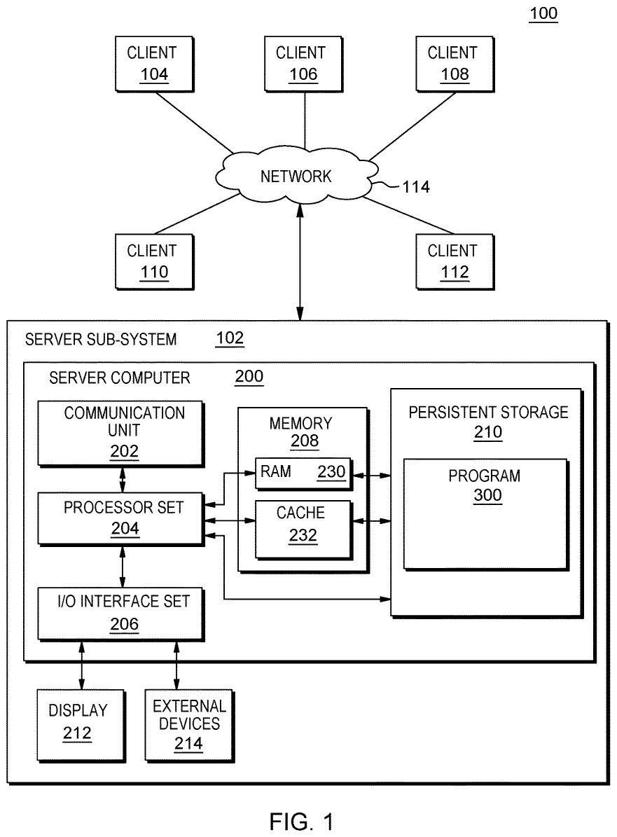

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

Under some currently conventional technology, there is a system and method of altering content provided to a user includes the steps of creating a user profile based on past physiological measurements of the user, monitoring at least one current physiological measurement of the user, and altering the content provided to the user based on the user profile and the at least one current physiological measurement. The user profile can be created by recording a plurality of inferred or estimated emotional states of the user which can include a time sequence of emotional states, stimulus contexts for such states, and a temporal relationship between the emotional state and the stimulus context. Stimulus context can include one or more among lighting conditions, sound levels, humidity, weather, temperature, other ambient conditions, and/or location. On the other hand, some embodiments of the present invention may include the following features: (i) as part of alerting to irrelevant and/or inappropriate video content, the computer system also suggests an activity for that short span to divert focus of the co-viewers so that at a later time point in the video content, the co-viewers present can again resume watching the video content as a group; and/or (ii) considers appropriateness and relevance of the video content with respect to all co-viewers and not merely with respect to a primary viewer (for example, the account holder of a streaming video content service might be considered as a primary viewer, but some embodiments of the present invention consider other co-viewers in addition to whomever the primary viewer might be considered to be in any given video viewing session situation.

Some currently conventional technology provides for some customization and filtration of channels. For example, affiliate groups can be used to mark, recommend or provide selective editing of video and other media that can be received by users. For example, one viewer may only have an interest in current event programming such as news or talk shows or sports and has no desire to watch children's shows or music videos. Under this currently conventional technology, a user can define such requirements and able to have a service that automatically locates, stores and recommends desired programming while at the same time hiding, blocking, filtering or screening unwanted programming. On the other hand, some embodiments of the present invention may include the following features: (i) filtering content happens by performing web crawling and not at a channel level; (ii) the process of filtration is dynamic in nature; (iii) content is filtered based on user or users viewing aspect and not based on fixed rules set up at channels or program level; and/or (iv) only a portion of the abusive content gets filtered.

Some currently conventional technology provides an event-based intelligent targeting engine capable of delivering highly relevant content, including, but not limited to, advertisements, alerts, messages, notifications, warnings, signals, machine-to-machine (M2M) telemetry, entertainment/media, and any communications thereof, based on real-time situations (that is, observed events) of a user as well as, historical preferences both explicitly stated or observed in behavior including demographics, psychographics, and sociographics, etc. On the other hand, some embodiments of the present invention may include the following features: (i) filters unwanted content based on wearable device feed; (ii) filters unwanted content based on home automation feed; and/or (iii) filters unwanted content based on user mobility aspects.

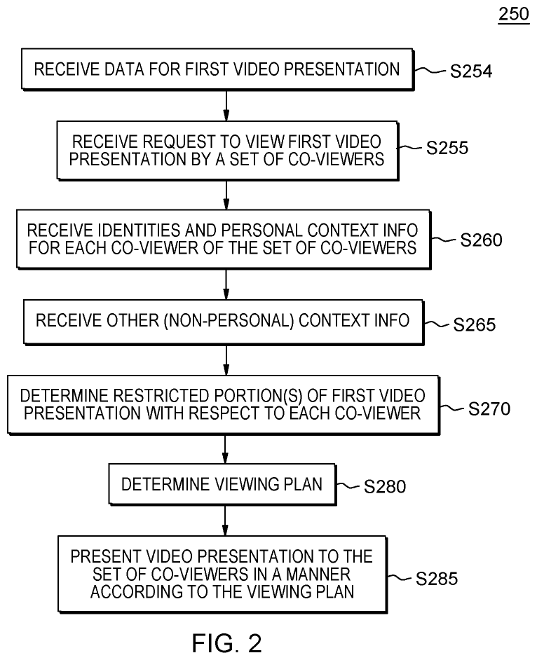

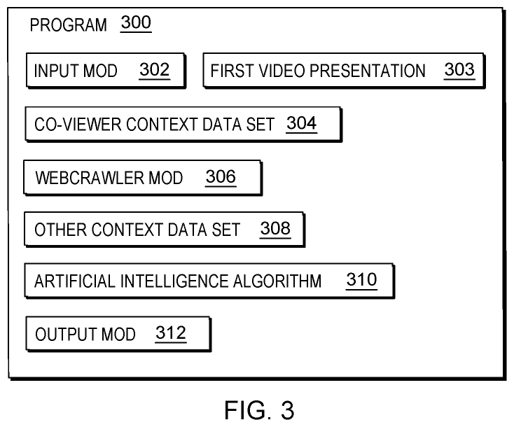

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S254, where input module (“mod”) 302 receives a streamable file corresponding to a first video presentation 303.

Processing proceeds to operation S255, where input module (“mod”) 302 receives a request to view video content on a first display (in this example, a television that is part of client subsystem 104. In this example, the request is received from a video streaming account holder that is in the same local environment as client subsystem 104, but not separately shown in FIG. 1. The request includes information identifying the first video program 303, which just happens to be resident on computer 102 due to operation S254, as the video content that multiple co-viewers would like to watch together.

In this example, the first video program regards the impeachment of a president that involved alleged misconduct in office of a sensitive nature. The first video program is educational in nature, despite its sensitive content. In this example, the first video program is organized so that the sensitive details of the alleged misconduct are discussed in two discrete portions of the video program. In this example, the sensitive portions begin with visual and audio sensitive content alerts that are included right in the video content of the first video presentation itself. These clear warnings will simplify the process of determining: (i) which co-viewers may be better spared the sensitive content, and also (ii) which co-viewers would benefit from the experience of watching the sensitive content because these details are relevant for fully understanding this part of human history, their sensitive nature notwithstanding.

Processing proceeds to operation S260, where input mod 302 receives co-viewer context data set 304 which includes information indicative of: (i) identities of all co-viewers that are likely to be watching the requested first video presentation along with the primary co-viewer (who is also considered as a co-viewer for purposes of this operation); and (ii) personal context information including attributes related to the co-viewers (including the primary viewer). In this example, there is one co-viewer who is a child of the primary viewer. The personal context of the child is: (i) the child's age is twelve (12) years old; and (ii) the child speaks only the following languages: (a) English (Southeastern United States dialect); and (b) Silbo Gomero. which is commonly spoken on the island of Gomera off the coast of Spain. The personal context of the parent is: (i) the parent's age is over 25 years old (exact age not known); and (ii) the parent speaks only the following languages: (a) English (Pacific Northeast United States dialect); (b) Silbo Gomero and (c) French.

Additionally and/or alternatively, other types of personal context are possible, including, without limitation, the following types of context: (i) nation of primary residence of an individual; (ii) state/city of primary residence of an individual; (iii) occupation(s) of an individual; (iv) educational background of an individual; (v) work history of an individual; (vi) the time, day or night, the user is watching, for example, during the week-end or late hours; and/or (vii) the user watching subscribed channels or recommended channels, for example, watching a fitness history channel (using health band data).

In this example, the co-viewer input data set includes information from: (i) an Internet of Things (IoT) subsystem with cameras and microphones that is included in subsystem 104 to determine the identities of the co-viewers (including the primary viewer); and (ii) webcrawling performed by webcrawling mod 306 directed at determining the ages of the co-viewer (a twelve year old child in this example) and languages for each co-viewer.

Processing proceeds to operation S265, where input mod 302 receives another context data set 308 which includes information indicative of other potentially relevant context information with respect to the planned viewing of the first video presentation. In this example, this other context information is obtained by webcrawling actions of webcrawler mod 306. In this example, the other potentially relevant context information includes: (i) time/date at which the request for viewing is received (for example, an individual may have different standards of propriety, some standards more exacting than others, at different times of the day, times of the month or times of the year); (ii) which nation (that is, wide geographic area) where the planned viewing will take place; (ii) which state and city (that is, narrow geographic area) the viewing is going to happen; (iii) the type of environment (for example, office, home, restaurant, hospital, etc.) where the viewing of the first video presentation is to take place; (iv) reviews and/or articles dealing with and/or describing the content of the first video presentation; (v) subscribed channels or recommended channels being viewed where the user has remote control; and/or (vi) reviewing a fitness schedule (soon after a gym workout or swimming session) by watching the streaming content.

Processing proceeds to operation S270, where artificial intelligence (AI) algorithm 310 determines, for each given co-viewer of the set of multiple co-viewers: (i) which portions (if any) of the first video presentation will be irrelevant for the given co-viewer; and (ii) which portions (if any) of the first video presentation will be inappropriate for the given co-viewer. In this simple example, the entire video content of the first video presentation is fully relevant to both co-viewers—both parent and child seek knowledge of this provocative episode of history which had important political consequences that reverberate to this very day. However, while relevant, some of the video content may be inappropriate for the 12 year old child due to its sensitive nature.

In making the determinations of operation S270 described in the previous paragraph, AI algorithm 310 takes as inputs: (i) requested first video presentation 303; (ii) other context data set 308; and (iii) co-viewer context data set 304. More specifically, the video content, and also the computer readable metadata, of requested video presentation 303 indicates and delineates two discrete portions that include sensitive matter, but no suggested age range cutoff threshold is suggested. However, considering other context data set 308, a review of the first video presentation written by a parenting authority, and available online, recommends that an individual should be at least 14 years of age to be expected to benefit from the sensitive portions of content of the first video presentation. Meanwhile, co-viewer context data set 304 indicates that one co-viewer is well over the age of 14, but the other co-viewer is younger than 14. This means, the bottom line is that: (i) the primary viewer should not be restricted, if feasible, from any parts of the video content of the first video presentation; (ii) the co-viewer should not be exposed to the audio portions marked as sensitive in the metadata of the video file itself; and (iii) the sensitive portions of the first video presentation do not include any sensitive visual content, but only sensitive audio content.

Processing proceeds to operation S280, where AI algorithm 310 determines a viewing plan so that: (i) no co-viewer sees irrelevant and/or inappropriate content; and (ii) the other co-viewers experience as much as possible with respect to the restricted portions. In some embodiments, this viewing plan may be as simple as “blurring out” certain visuals. Other types of viewing plan features are discussed in the next sub-section of this Detailed Description section. In this simple example, the viewing plan is that the audio will be switched into the French language for the sensitive parts as determined for the various co-workers at operation S275. In this way, the parent experiences the first video presentation in its substantive entirety, while the child blithely ignores the French parts.

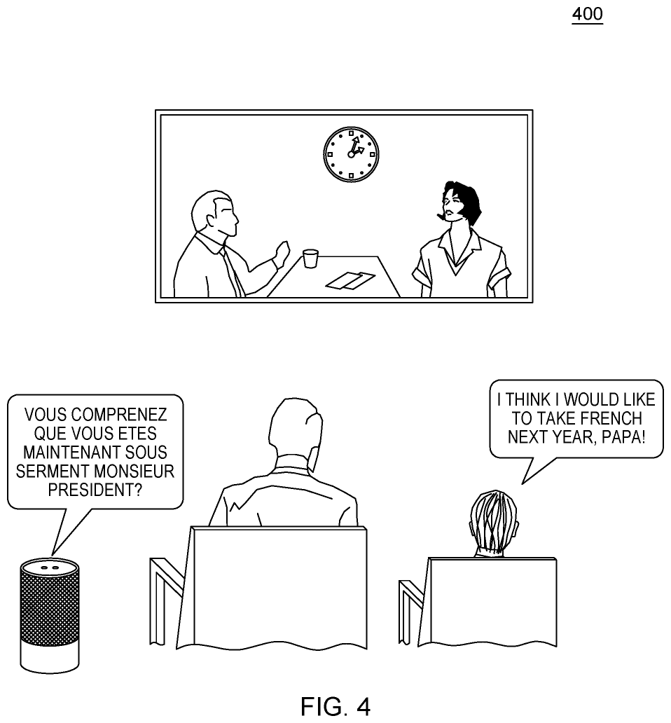

Processing proceeds to operation S285, where first video presentation 303 is streamed by output mod 312 to the two (2) co-viewers at client subsystem 114 in a manner that accords to the viewing plan developed at operation S280. This is shown in co-viewing session diagram 400 of FIG. 4.

### III. Further Comments and/or Embodiments

Some embodiments of the present invention recognize the following facts, potential problems and/or potential areas for improvement with respect to the current state of the art: (i) the relation between smart TV(s) and humans are common; (ii) most of the time users prefer to spend watching web series that span seasons (episodes) or watch movies across different entertainment applications along with other human users (for example, the family of a primary user) during certain time periods (for example, weekends) and for various different purposes (for example, entertainment, education, ambient videos for relaxation, etc.); (iii) the emotional and psychological subjective experiences of the various human viewers may vary from scene to scene, movie to movie, and/or web series to web series; (iv) in some cases content is restricted with respect to some human viewers while not being restricted with respect to other human viewers (for example, a movie that is rated “for mature audiences only”); (v) due to various types of audiences and different varieties of content available across different platforms, relevance mapping and restriction mapping is derived by considering the type of audience and the activity of the audience, which keeps varying; and/or (vi) sometimes it is required to get the attention from family members to consider what video content may be appropriate for any co-viewers or potential co-viewers.

Some embodiments of the present invention may include one, or more, of the following operations, features, characteristics and/or advantages: (i) a user/viewer/audience, group, or family members experience video content; (ii) uses video content captured from a wearable device feed, home automation feed, or a user mobility device; (iii) can be helpfully applied while watching TV or display devices; and/or (iv) uses an IoT (internet of things) and AI (artificial intelligence) based application system that can dynamically detect, manage, or operate TV channels to have a relevant and/or appropriate viewing experience for all co-viewer(s) based on the context; (v) audience preferences are respected; (vi) uses IoT and web series/TV feeds as input to automatically adjust the content and handle the associated embodiments of the smart TV to the viewer/audience; and/or (vii) the user's health and wellness is maintained.

Some embodiments of the present invention may include one, or more, of the following operations, features, characteristics and/or advantages: (i) a digital twin system to simulate the user wearable device feed, home automation feed, user mobility for web series or movie zoners that are trending and are of greater interest for a region/age group, or for a specific audience or user group; (ii) the augmented intelligence infused system can identify various associated embodiments of a smart TV like magic remote controllers, fire stick, etc.; (iii) IoT enabled systems such as, but not limited, to home automation systems or voice enabled systems to identify and analyze the usage pattern of the viewers or audience in the home; (iv) clusters viewers into different groups; (v) performs an entity-to-entity relationship mapping between clustered users and the streamed content; and/or (vi) dynamically invokes the augmented intelligence module to take control of the content and perform actions accordingly, such as clipping the content, audio filtering, or replacing it with some other content, etc.

Some embodiments of the present invention may include one, or more, of the following operations, features, characteristics and/or advantages: (i) the system understands the user commands (raw commands issued like crime movies, comedy movies, etc.,) through voice recognition techniques to enter a dialogue conversation beforehand to further fine tune the search content for the user based on feedback and answers received; and/or (ii) the system understands: (a) the dialogue conversation which includes drill down questions like regional aspects, (b) other users who are going to watch content with the viewer who requested the content and include any medical conditions, (c) performs a dynamic validation of responses received from the user, and/or (d) automatically changes the movie(s) or content to display to the user.

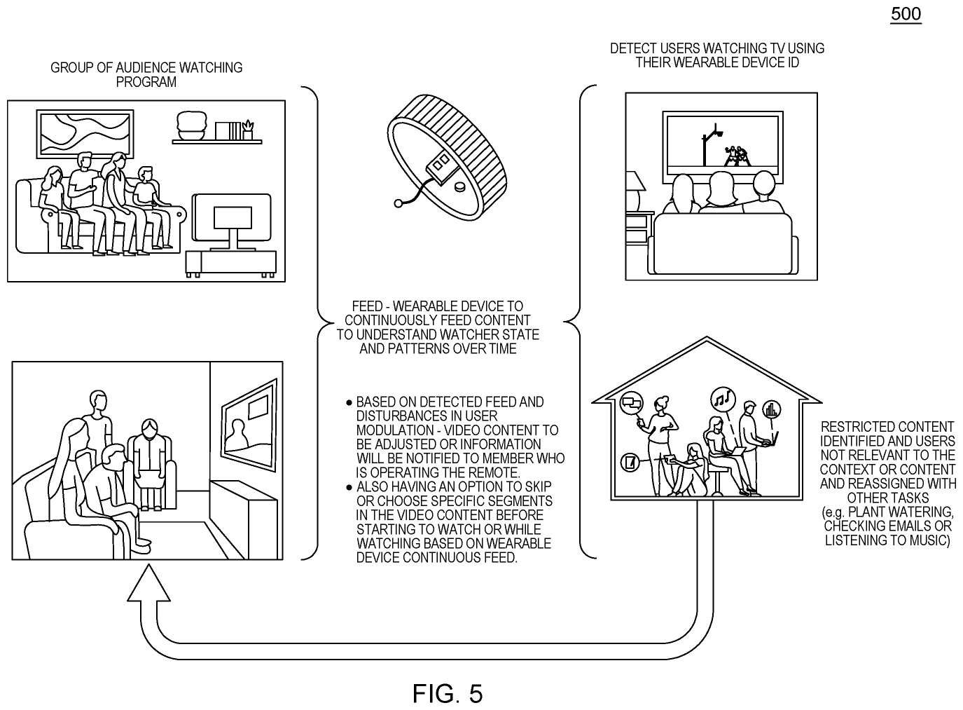

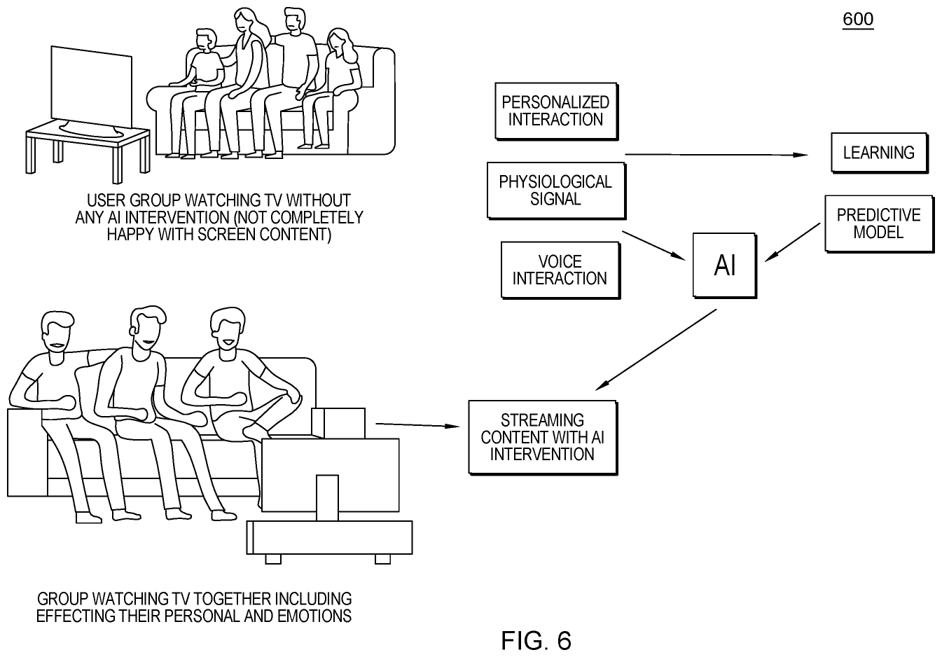

FIG. 5, diagram 500 and FIG. 6, diagram 600, are helpful in understanding embodiments of the present invention.

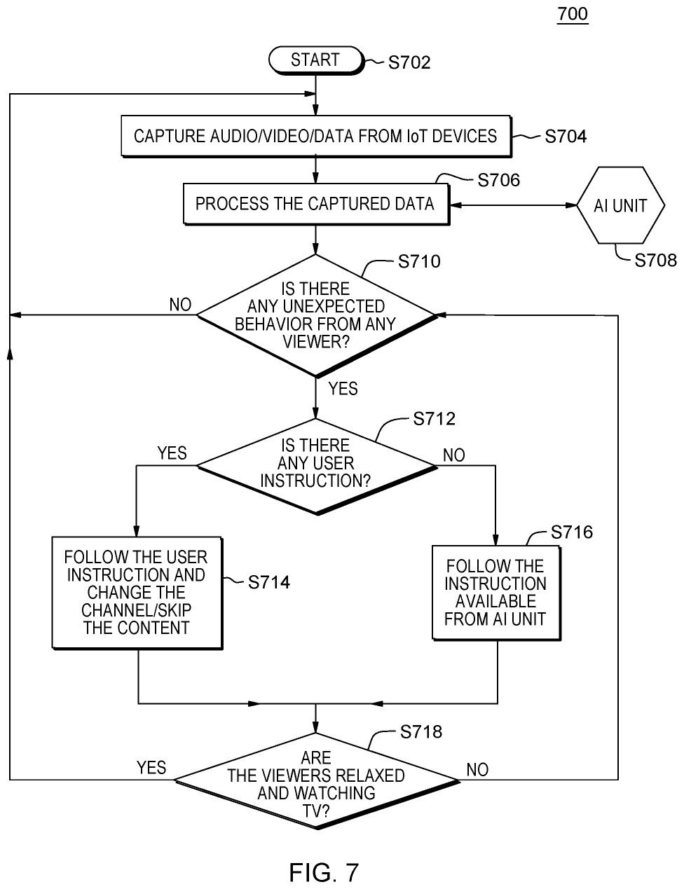

As shown in FIG. 7, flowchart 700 shows process flow for an embodiment of a method according to the present invention and includes: start block S702; capture audio/video/data from IoT devices block S704; process the captured data block S706; AI (artificial intelligence) unit block S708; unexpected behavior decision block S710; user instruction decision block S712; change/skip the content block S714; perform AI instructions block S716; and viewer status block S718.

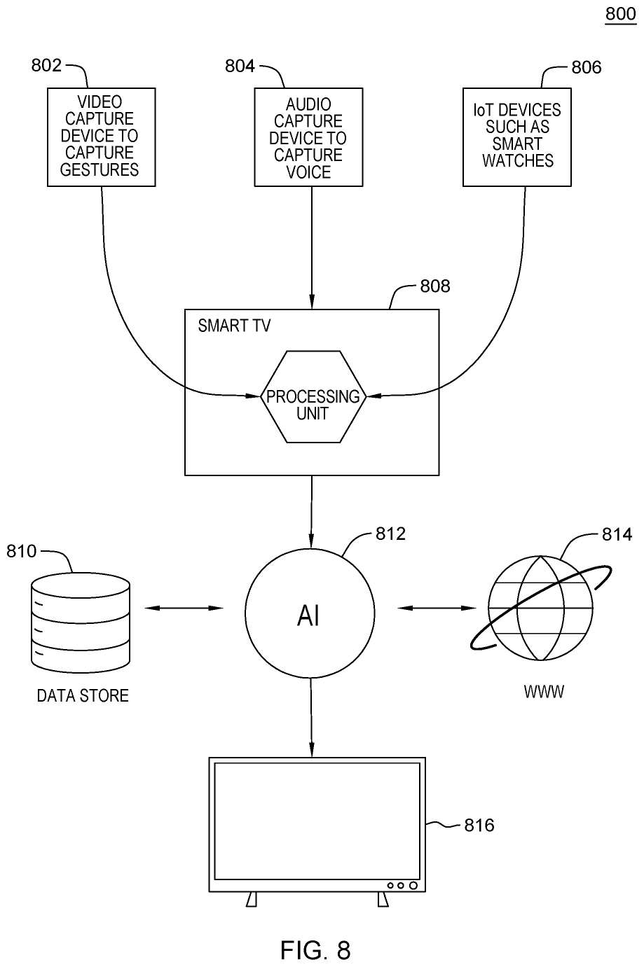

As shown in FIG. 8, computer system 800 includes: video capture device to capture gestures block 802; audio capture device to capture voice block 804; IoT devices such as smart watches block 806; smart TV/processing unit block 808; data storage 810; AI block 812; www (world wide web) 814; and display 816.

According to some embodiments of the present invention, the following is an example of the operations mentioned in the above paragraph. John requests a “Crime Movie” and the system further asks questions (based on content already in that app or web series) if any children are within the age group below 12 or 14, and if there are any viewers with heart issues, etc. then the system filters and fine tunes the search for every response received.

Some embodiments of the present invention may include one, or more, of the following operations, features, characteristics and/or advantages: (i) the system can perform web crawling or connect to various news and official telecom and government rules to automatically create an index of rules with respect to restricted content for that region/country; and/or (ii) automatically helps the user to avoid viewing or helps the viewer to notify the appropriate government channels when such content telecasted matches the restricted aspects which the system determines.

Some embodiments of the present invention may include one, or more, of the following operations, features, characteristics and/or advantages: (i) the user can wear a AR/VR (augmented reality/virtual reality) glasses to visualize different contextual needs; (ii) the user can select his/her favorite cartoon character or actor/actress and automatically visualize the content from all his/her subscribed platforms/apps in one place; and/or (iii) the user can walk through the content and visualize the co-audience or viewers wearable device feed for the requested content and mark them to show or not show.

According to some embodiments of the present invention, when a user in an AR/VR world marks it as “show content”, the system will impose the required control mechanism on the smart TV and associated embodiments and perform content trimming or filtering using existing technological embodiments.

Some embodiments of the present invention may include one, or more, of the following operations, features, characteristics and/or advantages: (i) the system control mechanism will allow family/friends to sit together and watch the streaming content without effecting their health or interest; and/or (ii) when a family is watching, based on available automation systems inside the home, the system can ensure people with different requirements can watch the content while others can be engaged in some other activity for that short span and again sit with their families and watch the remaining movie or content by enabling or disabling smart devices.

According to some embodiments of the present invention, the following is an example of the operations mentioned in the above paragraph. User A's wearable feed indicates there is more than a set threshold while viewing video content. The system detects and notifies the user to perform any household activity by automatically enabling or disabling the smart capabilities of that particular smart device, such as a dishwasher, vacuum cleaner, plant watering, etc.

Some embodiments of the present invention may include one, or more, of the following operations, features, characteristics and/or advantages: (i) historical viewer watching patterns will be stored in the smart TV; (ii) the system will have details of all family members or audience members from their social profile or conversation at home; (iii) using an IoT device, the system will also track various external and internal influencing factors, including users wearable feed, home automation feed, and health condition captured while watching the content; (iv) the system will be alerting viewers to understand nearby user interests/preferences and suggest changing the channel or forward the relevant content based on the context; (v) the system will segregate media content into different segments such as comedy, suspense, skip violence, skip objectionable material; and/or (vi) show cinematography specific scenes.

Some embodiments of the present invention may include one, or more, of the following operations, features, characteristics and/or advantages: (i) the system provides an option to choose or skip specific segments while watching with specific groups; (ii) built-in AI unit which will learn any new viewer behavior; (iii) uploads/downloads behavior patterns from a common storage; (iv) the viewer can override the standing instructions of the system; (v) continuously captures audio/video and data from paired IoT devices (such as smart watches); (vi) the system will analyze the data captured from audio/video devices and paired IoT devices; (vii) if the system finds any abnormal behavior, it will immediately follow any instruction stored by the viewer; (viii) if the system doesn't find any instruction from the viewer, it will follow the standing built in instructions; (ix) the instructions can be, but are not limited to, skipping the content, change the channel, and/or reduce the volume; and/or (x) whenever connected to the internet, the system will have the ability to upgrade itself (trained module and standing instruction) if so configured.

Some embodiments of the present invention may include one, or more, of the following operations, features, characteristics and/or advantages: (i) not required to perform any dry run to first capture the user's behavior; (ii) the system performs live; (iii) the system skips unwanted content or irrelevant content; (iv) includes the feature of having user group rules; (v) includes emotion detection; and/or (vi) can be used by an implementation model.

Some embodiments of the present invention may include one, or more, of the following operations, features, characteristics and/or advantages: (i) dynamically adjusts content display (video content) for a viewer/user/audience by capturing viewer/user/audience preferences from wearable device feeds, Internet of things (IoT) home automation/television (TV) feeds, and user mobility; (ii) not limited to content filtering or audio filtering; (iii) utilizes a digital twin module to simulate user reactions for web series or movies that are trending and are of greater interest for a region/age group; (iv) automatically creates avatars programmed with different attributes based on clustered wearable feed to capture and record user responses; and/or (v) when a user in an AR/VR world marks it as “show content”, the system will impose the required control mechanism on the smart TV and associated embodiment, and the content trimming or filtering, using existing technological, embodiments are automatically applied for that users profile in the smart TV.

Some embodiments of the present invention may include one, or more, of the following operations, features, characteristics and/or advantages: (i) dynamically adjusts content display (video content) for a viewer/user/audience; (ii) captures viewer/user/audience preferences from wearable device feeds, Internet of things (IoT) home automation/television (TV) feeds, and user mobility; and/or (iii) differs in method and is not limited to aspects of advertisement content or combining media segments.

Some embodiments of the present invention may include one, or more, of the following operations, features, characteristics and/or advantages: (i) suggests an activity for a short time span to divert user focus where, at a later time, the viewers can continue to watch as a group; (ii) filtering content is performed by web crawling which is not required to be done at the channel level; (iii) is dynamic in nature; (iv) filters content based on user or users viewing aspect, where filtering is not based on fixed rules set up at the channel or program level; (v) only filters out the abusive content; and/or (vi) filters unwanted content based on wearable device feed, home automation feed. and user mobility aspects.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) for use with a first video presentation data set that includes audiovisual content in the form of a first video presentation and further for use with a plurality of co-viewers who want to watch the first video presentation together as a group, the CIM comprising:
receiving, from the first co-viewer and through a communication network, a request to view the first video presentation on a first audiovisual presentation device of the first co-viewer;
receiving a co-viewer context data set which includes information indicative of: (i) identities of all co-viewers of the plurality of co-viewers, and (ii) for each given co-viewer of the plurality of co-viewers, personal context information including attributes related to the given co-viewer; and
for each given co-viewer of the plurality of co-viewers, determining, based at least in part on the co-viewer context data set, by an artificial intelligence algorithm: (i) irrelevant portions, if any, of the first video presentation that are irrelevant with respect to the given co-viewer, and (ii) inappropriate portions, if any, of the first video presentation will be inappropriate for the given co-viewer.

2. The CIM of claim 1 further comprising:
presenting, on the first audiovisual presentation device and for the plurality of co-viewers, the first video presentation in a manner that omits, obscures and/or distracts from any portions that are irrelevant and/or inappropriate for any co-viewer of the plurality of co-viewers.

3. The CIM of claim 1 further comprising:
determining, by the artificial intelligence algorithm, a viewing plan under which each given co-viewer of the plurality of co-viewers: (i) is unlikely to experience any content that is irrelevant and/or inappropriate with respect to that co-viewer, and (ii) is presented with as much of the audiovisual content of the first video presentation as feasible and in a manner in consistent with the previous item on this list.

4. The CIM of claim 1 further comprising:
presenting, in accordance with the viewing plan, the first audiovisual presentation device for the plurality of co-viewers.

5. The CIM of claim 1 further comprising:
receiving an environmental context data set that includes information indicative of a context in which the plurality of co-viewers want to view the first video presentation on the first audiovisual presentation data set;
wherein the receipt of the co-viewer context data set includes:
receiving, from an Internet of Things (IoT) device and through a communication network, a first audiovisual presentation device environment data set, and
determining identities of the co-viewers of the plurality of co-viewers based on the first audiovisual presentation device environment data set.

6. The CIM of claim 1 further comprising:
receiving an environmental context data set that includes information indicative of a context in which the plurality of co-viewers want to view the first video presentation on the first audiovisual presentation data set;
the determination of irrelevant portions and inappropriate portions is further based, at least in part, on the environmental context data set.

7. A computer-implemented method (CIM) for use with a first video presentation data set that includes audiovisual content in the form of a first video presentation and further for use with a plurality of co-viewers who want to watch the first video presentation together as a group, the CIM comprising:
receiving, from the first co-viewer and through a communication network, a request to view the first video presentation on a first audiovisual presentation device of the first co-viewer;
receiving a co-viewer context data set which includes information indicative of: (i) identities of all co-viewers of the plurality of co-viewers, and (ii) for each given co-viewer of the plurality of co-viewers, personal context information including attributes related to the given co-viewer; and
for each given co-viewer of the plurality of co-viewers, determining, based at least in part on the co-viewer context data set, by an artificial intelligence algorithm, irrelevant portions, if any, of the first video presentation that are irrelevant with respect to the given co-viewer.

8. The CIM of claim 7 further comprising:
presenting, on the first audiovisual presentation device and for the plurality of co-viewers, the first video presentation in a manner that omits, obscures and/or distracts from any portions that are irrelevant for any co-viewer of the plurality of co-viewers.

9. The CIM of claim 7 further comprising:
determining, by the artificial intelligence algorithm, a viewing plan under which each given co-viewer of the plurality of co-viewers: (i) is unlikely to experience any content that is irrelevant with respect to that co-viewer, and (ii) is presented with as much of the audiovisual content of the first video presentation as feasible and in a manner in consistent with the previous item on this list.

10. The CIM of claim 7 further comprising:
presenting, in accordance with the viewing plan, the first audiovisual presentation device for the plurality of co-viewers.

11. The CIM of claim 7 further comprising:
receiving an environmental context data set that includes information indicative of a context in which the plurality of co-viewers want to view the first video presentation on the first audiovisual presentation data set;
wherein the receipt of the co-viewer context data set includes:
receiving, from an Internet of Things (IoT) device and through a communication network, a first audiovisual presentation device environment data set, and
determining identities of the co-viewers of the plurality of co-viewers based on the first audiovisual presentation device environment data set.

12. The CIM of claim 7 further comprising:
receiving an environmental context data set that includes information indicative of a context in which the plurality of co-viewers want to view the first video presentation on the first audiovisual presentation data set;
the determination of irrelevant portions is further based, at least in part, on the environmental context data set.

13. A computer-implemented method (CIM) for use with a first video presentation data set that includes audiovisual content in the form of a first video presentation and further for use with a plurality of co-viewers who want to watch the first video presentation together as a group, the CIM comprising:
receiving, from the first co-viewer and through a communication network, a request to view the first video presentation on a first audiovisual presentation device of the first co-viewer;
receiving a co-viewer context data set which includes information indicative of: (i) identities of all co-viewers of the plurality of co-viewers, and (ii) for each given co-viewer of the plurality of co-viewers, personal context information including attributes related to the given co-viewer; and
for each given co-viewer of the plurality of co-viewers, determining, based at least in part on the co-viewer context data set, by an artificial intelligence algorithm inappropriate portions, if any, of the first video presentation will be inappropriate for the given co-viewer.

14. The CIM of claim 13 further comprising:
presenting, on the first audiovisual presentation device and for the plurality of co-viewers, the first video presentation in a manner that omits, obscures and/or distracts from any portions that are inappropriate for any co-viewer of the plurality of co-viewers.

15. The CIM of claim 13 further comprising:
determining, by the artificial intelligence algorithm, a viewing plan under which each given co-viewer of the plurality of co-viewers: (i) is unlikely to experience any content that is inappropriate with respect to that co-viewer, and (ii) is presented with as much of the audiovisual content of the first video presentation as feasible and in a manner in consistent with the previous item on this list.

16. The CIM of claim 13 further comprising:
presenting, in accordance with the viewing plan, the first audiovisual presentation device for the plurality of co-viewers.

17. The CIM of claim 13 further comprising:
receiving an environmental context data set that includes information indicative of a context in which the plurality of co-viewers want to view the first video presentation on the first audiovisual presentation data set;
wherein the receipt of the co-viewer context data set includes:
receiving, from an Internet of Things (IoT) device and through a communication network, a first audiovisual presentation device environment data set, and
determining identities of the co-viewers of the plurality of co-viewers based on the first audiovisual presentation device environment data set.

18. The CIM of claim 13 further comprising:
receiving an environmental context data set that includes information indicative of a context in which the plurality of co-viewers want to view the first video presentation on the first audiovisual presentation data set;
the determination of inappropriate portions is further based, at least in part, on the environmental context data set.
